(19) United States
(12) Patent Application Publication
(10) Pub. No.: US 2019/0089731 A1
(43) Pub. Date: Mar. 21, 2019

(54) ABUSER DETECTION

(71) Applicant: Camp Mobile Corporation, Seoul (KR)

(72) Inventors: Hyung-Seok Park, Seoul (KR); Sungwon Jung, Seoul (KR); Hyunmyung Kim, Seoul (KR); Sungju Kwon, Seoul (KR)

(73) Assignee: Camp Mobile Corporation, Seoul (KR)

(21) Appl. No.: 16/137,642

(22) Filed: Sep. 21, 2018

(30) Foreign Application Priority Data
Sep. 21, 2017 (KR) 10-2017-0121622

(51) Int. Cl. H04L 29/06; G06N 7/00; G06N 99/00

(52) U.S. Cl. CPC H04L 63/1441; G06N 99/005; G06N 7/005

(57) ABSTRACT

An abuser detection method, apparatus, system, and/or non-transitory computer readable medium may decrease and/or prevent an occurrence of abuse by detecting an abuser based on features of users of a service and imposing a restriction on the abuser before the abuse occurs.

### CROSS-REFERENCE TO RELATED APPLICATION(S)

This U.S. non-provisional application claims the benefit of priority under 35 U.S.C. § 119 to Korean Patent Application No. 10-2017-0121622 filed on Sep. 21, 2017, in the Korean Intellectual Property Office (KIPO), the entire contents of which are incorporated herein by reference.

### BACKGROUND

### Field

One or more example embodiments relate to abuser detection technology and, more particularly, to an abuser detection method that may reduce and/or prevent occurrence of abuse by detecting an abuser of an online service based on features of users of the online service and imposing a restriction on the abuser before abuse occurs, a computer apparatus and/or computer implemented system that perform the abuser detection method, and/or a non-transitory computer-readable recording medium storing instructions that, when executed by at least one processor, cause the at least one processor to perform the abuser detection method.

### Description of Related Art

Various types of online services provided through a network suffer from abusers who desire to obtain benefits from unfair and/or abusive acts. For example, the abusers may include spammers trying to expose unwanted advertising posts (e.g., spam posts) to a number of specific or unspecific users through a Social Networking Service (SNS), website, forum, instant messaging system, email system, SMS network, telephone network, etc.

In the past, to detect such abusers, people directly determined abusive, unwanted, and/or annoying behaviors, for example, administrators directly detected abuse by abusers and/or suspected and/or detected abusers through reports from users. However, it is very difficult, if not impossible, in practice for the administrators to examine all uploaded data or all behaviors of users performed in a service. An abuser detection system that relies on reports from users requires active cooperation from the users, and thus is only a passive measure against abuse.

In this regard, a great deal of effort has been made to systematically detect abusers, such as methods and systems for detecting the occurrence of spam. However, existing systems only detect an occurrence of abuse and an abuser by analyzing advertising posts after the abuse has already occurred, for example, after the advertising posts were uploaded. Thus, it is very difficult and/or impossible to decrease and/or prevent such abusive behavior before abuse occurs.

In addition, the existing technology takes disciplinary action which abusers may perceive, for example, account blocking, against detected abusers, and thus the abusers may analyze an abuser detection scheme and avoid abuser detection by modifying their behavior, such as creating new accounts, changing wording of their spam posts, submitting posts from different IP addresses, etc.

### SUMMARY

One or more example embodiments provide an abuser detection method that may decrease and/or prevent an occurrence of abuse by detecting an abuser based on features of users of a service and imposing a restriction on the abuser before abuse occurs, a computer apparatus that performs the abuser detection method, and a non-transitory computer-readable recording medium storing instructions that, when executed by a processor, cause the processor to perform the abuser detection method.

One or more example embodiments provide an abuser detection method that may impose, on detected abusers, an abuser-imperceptible restriction that is not perceptible by the detected abusers such that the detected abusers may not make an effort to analyze an abuser detection scheme or avoid abuser detection, a computer apparatus that performs the abuser detection method, and a non-transitory computer-readable recording medium storing instructions that, when executed by a processor, cause the processor to perform the abuser detection method.

According to an aspect of at least one example embodiment, there is provided an abuser detection method including generating feature data associated with activities of users pre-specified as abusers among users of a service provided through a network, generating an abuser behavior model through machine learning with respect to the generated feature data, calculating an abuser probability for an individual user by analyzing feature data accumulated with respect to the individual user through the abuser behavior model, each time the individual user performs a new activity, and determining whether each of the users of the service is an abuser based on an abuser probability calculated for each of the users of the service.

According to an aspect of at least one example embodiment, there is provided a non-transitory computer-readable recording medium storing instructions that, when executed by a processor, cause the processor to perform the abuser detection method.

According to an aspect of at least one example embodiment, there is provided a computer apparatus including at least one processor configured to execute computer-readable instructions, wherein the at least one processor is configured to generate feature data associated with activities of users pre-specified as abusers among users of a service provided through a network, generate an abuser behavior model through machine learning with respect to the generated feature data, calculate an abuser probability for an individual user by analyzing feature data accumulated with respect to the individual user through the abuser behavior model, each time the individual user performs a new activity, and determine whether each of the users of the service is an abuser based on an abuser probability calculated for each of the users of the service.

According to some example embodiments, it is possible to decrease and/or prevent an occurrence of abuse by detecting an abuser based on features of users of a service and imposing a restriction on the abuser before abuse occurs.

According to some example embodiments, it is possible to impose, on detected abusers, an abuser-imperceptible restriction that is not perceptible by the detected abusers such that the detected abusers may not make an effort to analyze an abuser detection scheme or avoid abuser detection.

Further areas of applicability will become apparent from the description provided herein. The description and specific examples in this summary are intended for purposes of illustration only and are not intended to limit the scope of the present disclosure.

### BRIEF DESCRIPTION OF THE FIGURES

Example embodiments will be described in more detail with regard to the figures, wherein like reference numerals refer to like parts throughout the various figures unless otherwise specified, and wherein:

FIG. 1 is a diagram illustrating an example of a network environment according to at least one example embodiment;

FIG. 2 is a block diagram illustrating a configuration of an electronic device and a server according to at least one example embodiment;

FIG. 3 is a diagram illustrating an example of an overall process for abuser detection according to at least one example embodiment;

FIG. 4 is a diagram illustrating an example of a dataflow according to at least one example embodiment;

FIG. 5 is a diagram illustrating an example of a loop structure of abuser detection and training of an abuser behavior model according to at least one example embodiment;

FIGS. 6 through 9 illustrate an abusing process and an example of determining a user to be an abuser and setting an abuser-imperceptible restriction in response to the abusing process; and

FIG. 10 is a flowchart illustrating an example of an abuser detection method according to at least one example embodiment.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given example embodiment, and should not be interpreted as defining or limiting the range of values or properties encompassed by example embodiments.

### DETAILED DESCRIPTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware and/or a combination of hardware and software. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor), Central Processing Unit (CPU), a controller, an arithmetic logic unit (ALU), a digital signal processor, a microcomputer, a microprocessor, etc., the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes specially programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable storage mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of the example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors, multi-core processors, or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, example embodiments will be described with reference to the accompanying drawings.

An abuser detection method according to some example embodiments may be performed by a computer apparatus such as a server described below. Here, a computer program according to an example embodiment may be installed and executed on the computer apparatus. The computer apparatus may perform the abuser detection method under control of the executed computer program. The computer program may be stored in a non-transitory computer-readable recording medium to implement the abuser detection method on a computer in conjunction with the computer apparatus.

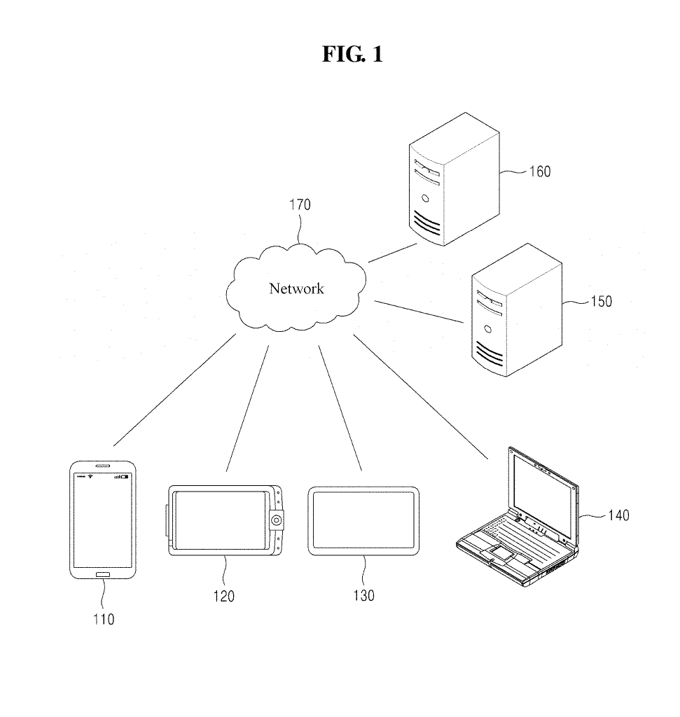

FIG. 1 is a diagram illustrating an example of a network environment according to at least one example embodiment. Referring to FIG. 1, the network environment includes a plurality of electronic devices 110, 120, 130, and 140, a plurality of servers 150 and 160, and a network 170. FIG. 1 is provided as an example only and thus, the number of electronic devices and/or the number of servers are not limited thereto, and may be a lesser or greater amount.

Each of the plurality of electronic devices 110, 120, 130, and 140 may be a fixed terminal or a mobile terminal configured as a computer apparatus. For example, the plurality of electronic devices 110, 120, 130, and 140 may be a smartphone, a mobile phone, a navigation device, a computer, a laptop computer, a digital broadcasting terminal, a personal digital assistant (PDA), a portable multimedia player (PMP), a tablet personal computer (PC), a gaming console, a virtual reality and/or augmented reality device, an Internet of Things (IoT) device, a smarthome device, and the like. For example, although FIG. 1 illustrates the electronic device 110 in the shape of a smartphone, it is provided as an example only. Here, the electronic device 110 may refer to any type of various physical computer apparatuses capable of communicating with other electronic devices 120, 130, and/or 140, and/or the servers 150 and/or 160 over the network 170 in a wired communication manner and/or in a wireless communication manner.

The communication scheme is not particularly limited and may include a communication method that uses a near field communication between devices as well as a communication method using a communication network, for example, a mobile communication network, the wired Internet, the wireless Internet, a broadcasting network, etc., which may be included in the network 170. For example, the network 170 may include at least one of network topologies that include networks, for example, a personal area network (PAN), a local area network (LAN), a campus area network (CAN), a metropolitan area network (MAN), a wide area network (WAN), a broadband network (BBN), the Internet, and the like. Also, the network 170 may include at least one of network topologies that include a bus network, a star network, a ring network, a mesh network, a star-bus network, a tree or hierarchical network, and the like. However, it is only an example and the example embodiments are not limited thereto.

Each of the servers 150 and 160 may be configured as a computer apparatus or a plurality of computer apparatuses that provides instructions, codes, files, contents, services, and the like through communication with the plurality of electronic devices 110, 120, 130, and/or 140 over the network 170. For example, the server 150 may be a system that provides, for example, a first service associated with the plurality of electronic devices 110, 120, 130, and/or 140 connected over the network 170. The server 160 may be a system that provides, for example, at least one second service associated with the plurality of electronic devices 110, 120, 130, and/or 140 connected over the network 170. In detail, the server 150 may provide, as the first service, a service for processing an abuser detection method according to at least one example embodiment. As another example, the server 160 may provide the plurality of electronic devices 110, 120, 130, and/or 140 with a variety of services, for example, a social network service (SNS), a messaging service, a voice call service, a video call service, a search service, an information providing service, a mail service, a gaming service, and/or a content providing service (e.g., online media, websites, etc.), etc., as the at least one second service. In this case, the server 150 may provide a service for abuser detection as the first service in association with the at least one second service provided from the server 160, however the example embodiments are not limited thereto and, for example, a single server may provide both the first service and the at least one second service, or a plurality of servers may provide one or both of the first service and the at least one second service, etc.

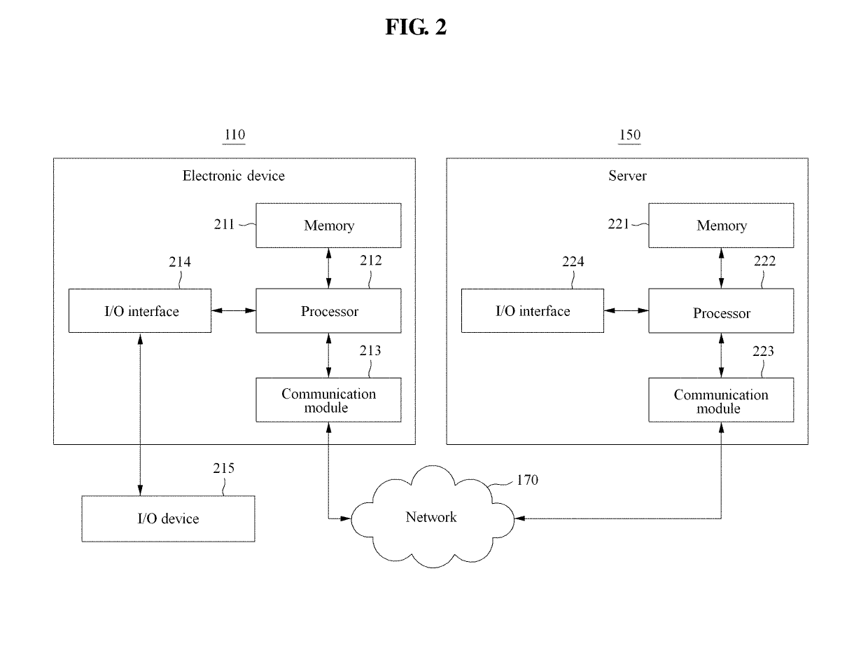

FIG. 2 is a block diagram illustrating an example of a configuration of an electronic device and a server according to at least one example embodiment. FIG. 2 illustrates a configuration of the electronic device 110 as an example for a single electronic device and illustrates a configuration of the server 150 as an example for a single server. The same or similar components may be applicable to other electronic devices 120, 130, and/or 140, or the server 160, and also to still other electronic devices or still other servers.

Referring to FIG. 2, the electronic device 110 may include a memory 211, at least one processor 212, a communication module 213, and an input/output (I/O) interface 214, but is not limited thereto. The server 150 may include a memory 221, at least one processor 222, a communication module 223, and an I/O interface 224, but is not limited thereto. The memory 211, 221 may include a permanent mass storage device, such as random access memory (RAM), read only memory (ROM), and a disk drive, etc., as a non-transitory computer-readable storage medium. Here, the permanent mass storage device, such as ROM and disk drive, etc., may be included in the electronic device 110 or the server 150 as a permanent storage device separate from the memory 211, 221. Also, an OS or at least one program code, for example, a code for an application for providing a specific service installed on the electronic device 110 and/or a browser installed and executed on the electronic device 110, may be stored in the memory 211, 221. Such software components may be loaded from another non-transitory computer-readable storage medium separate from the memory 211, 221 using a drive mechanism. The other non-transitory computer-readable storage medium may include, for example, a floppy drive, a disk, a tape, a Blu-ray/DVD/CD-ROM drive, a memory card, etc. According to other example embodiments, software components may be loaded to the memory 211, 221 through the communication module 213, 223, instead of, or in addition to, the non-transitory computer-readable storage medium. For example, at least one program may be loaded to the memory 211, 221 based on a computer program, for example, the application, installed by files provided over the network 170 from developers or a file distribution system, for example, the server 160, which provides an installation file of the application.

The processor 212, 222 may be configured to process computer-readable instructions of a computer program by performing basic arithmetic operations, logic operations, and I/O operations. The computer-readable instructions may be provided from the memory 211, 221 and/or the communication module 213, 223 to the processor 212, 222. For example, the processor 212, 222 may be configured to execute received instructions in response to the program code stored in the storage device, such as the memory 211, 222, thereby transforming the processor 212, 222 into a special purpose processor for performing the functionality of the program code.

The communication module 213, 223 may provide a function for communication between the electronic device 110 and the server 150 over the network 170, and may provide a function for communication between the electronic device 110 and/or the server 150 and another electronic device, for example, the electronic device 120 or another server, for example, the server 160. For example, the processor 212 of the electronic device 110 may transfer a request created based on a program code stored in the storage device such as the memory 211, to the server 150 over the network 170 under control of the communication module 213. Inversely, a control signal, an instruction, content, a file, etc., provided under control of the processor 222 of the server 150 may be received at the electronic device 110 through the communication module 213 of the electronic device 110 by going through the communication module 223 and the network 170. For example, a control signal, an instruction, content, a file, etc., of the server 150 received through the communication module 213 may be transferred to the processor 212 or the memory 211, and content, a file, etc., may be stored in a storage medium, for example, the permanent storage device, further includable in the electronic device 110.

The I/O interface 214 may be a device used for interface with an I/O device 215. For example, an input device may include a device, such as a keyboard, a mouse, a microphone, a camera, etc., and an output device may include a device, such as a display, a projector, a speaker, etc. As another example, the I/O interface 214 may be a device for interface with an apparatus in which an input function and an output function are integrated into a single function, such as a touchscreen. The I/O device 215 may be configured as a single device with the electronic device 110. Also, the I/O interface 224 of the server 150 may be a device used for connection with the server 150 or for interface with a device (not shown) for input or output includable in the server 150. In detail, when processing instructions of the computer program loaded to the memory 211, the processor 212 of the electronic device 110 may display a service screen configured using data provided from the server 150 or the electronic device 120, or may display content on a display through the I/O interface 214.

According to other example embodiments, the electronic device 110 and the server 150 may include a greater or lesser number of components than a number of components shown in FIG. 2. For example, the electronic device 110 may include at least a portion of the I/O device 215, or may further include other components, for example, a transceiver, a global positioning system (GPS) module, a camera, a variety of sensors, a database, and the like. In detail, if the electronic device 110 is a smartphone, the electronic device 110 may be configured to further include a variety of components, for example, an accelerometer sensor, a gyro sensor, a camera module, various physical buttons, a button using a touch panel, an I/O port, a haptic feedback motor for vibration, etc., which are generally included in the smartphone.

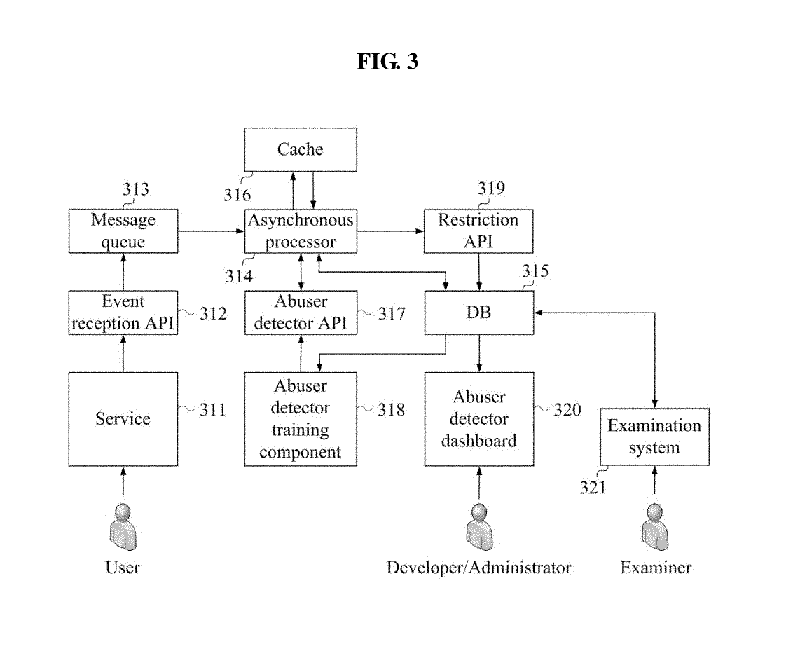

FIG. 3 is a diagram illustrating an example of an overall process for abuser detection according to at least one example embodiment.

A service 311 may be, for example, a service provided through the server 160 accessed by the electronic device 110 by controlling an application installed and run on the electronic device 110. In an example in which a user performs an activity through the service 311, the service 311 may transmit an event corresponding to the performed activity to a system for abuser detection (e.g., a system for detecting an abuser of the other users of the service, a spammer, a troll, a cheater, a bot, an unwanted/undesirable user, etc.), for example, the server 150, using an event reception application programming interface (API) 312. The event transmitted to the system for abuser detection may be stored in a message queue 313 included in the system for abuser detection.

The system for abuser detection may asynchronously and sequentially process events stored in the message queue 313 (e.g., a message and/or content queue associated with the service 311) through an asynchronous processor 314. In this example, the asynchronous processor 314 may extract feature data associated with activities through the events stored in the message queue 313 and determine whether the user is an abuser based on the extracted feature data accumulated with respect to the user. The feature data accumulated with respect to the user may be stored in a database (DB) 315, and the asynchronous processor 314 may retrieve the feature data accumulated with respect to the user from the DB 315 and reflect the feature data extracted through the events in the accumulated feature data. The accumulated feature data reflecting the feature data extracted through the events may be stored in the DB 315 again, whereby the feature data accumulated with respect to the user may be updated. Further, the asynchronous processor 314 may determine whether the user is an abuser (e.g., an abuser of other users of the service, a spammer, a troll, a cheater, a bot, an unwanted/undesirable user, etc.) based on the accumulated feature data reflecting the feature data extracted through the events.

Meanwhile, the asynchronous processor 314 may utilize a cache 316 for much faster processing. A snapshot with respect to the latest feature data of the user that is processed once may be stored in the cache 316. There may be a user who frequently uses the service 311, whereas there may exist a user who relatively rarely uses the service 311. Thus, snapshots with respect to the latest feature data of users who frequently use the service 311 may be retrieved quickly from the cache 316, so that the asynchronous processor 314 may retrieve the feature data accumulated with respect to the user more quickly. A snapshot with respect to the accumulated feature data reflecting the feature data extracted through the events may be stored in the cache 316.

The asynchronous processor 314 may obtain an abuser probability for the user (e.g., a probability, score, etc., that the user is an abuser of other users of the service, a spammer, a troll, a cheater, a bot, an unwanted/undesirable user, etc.) through an abuser detector API 317. For example, the asynchronous processor 314 may use the feature data finally accumulated with respect to the user as parameters for an API call of an abuser behavior model provided by an abuser detector training component 318, and the abuser behavior model may process the parameters and return an abuser probability. The asynchronous processor 314 may determine whether the user is an abuser based on whether the returned abuser probability exceeds a desired and/or preset threshold (for example, 70%). For example, assuming an abuser probability calculated for a user A is 77%, the asynchronous processor 314 may determine the user A to be an abuser. Additionally, the abuser probability threshold may be adjusted based on empirical studies of the users of the service.

In this example, the asynchronous processor 314 may request a restriction on the user (e.g., a restriction on the access of the user to the service, such as a temporary ban for the user, a permanent ban for the user, disabling the user from being able to communicate with other users on the service and/or post messages/content to the service, flagging the user as a suspected abuser, automatically flagging messages/posts/content transmitted by the user as suspected abuse/spam, etc.) determined to be an abuser through a restriction API 319. In this example, the restriction on the user determined to be an abuser may be set in the DB 315 through the restriction API 319. Later, when the corresponding user uses the service 311, information associated with the corresponding user may be retrieved from the DB 315 by the server 160 providing the service 311, and the server 160 may verify that there is a restriction set for the corresponding user in relation to the service 311. In this example, the server 160 may apply the restriction set for the user to the service 311. The restriction on the abuser will be described further below.

Meanwhile, the feature data stored in the DB 315 or information such as the contents of the restriction set in the DB 315 may be provided to a developer and/or an administrator through a user interface (UI) such as an abuser detector dashboard 320. Further, the feature data stored in the DB 315 or the information such as the contents of the restriction set in the DB 315 may be examined through an examination system 321. The examination system 321 may provide a UI for an examiner (e.g., an administrator, an account manager, a customer service representative, etc.) to detect an abuser using the information stored in the DB 315, separately from the asynchronous processor 314.

Further, the accumulated feature data of the user reflecting the feature data extracted through the events may be transmitted to the abuser detector training component 318. In this example, the abuser detector training component 318 may train the abuser behavior model through machine learning with respect to the received feature data. Machine learning may be implemented by utilizing various well-known tools or algorithms. For example, Scikit-learn or Python may be utilized as a tool for machine learning, and Random Forest may be utilized as an algorithm for machine learning, but the example embodiments are not limited thereto.

In this example, the feature data transmitted to train the abuser behavior model may include feature data of users pre-specified and/or known as abusers. At first, examiners may examine feature data through a UI provided by the examination system 321, and feature data of users specified as abusers may be utilized to train the abuser behavior model. However, after the training of the abuser behavior model is performed to an appropriate level, the feature data of the users specified as abusers by the asynchronous processor 314 may be utilized to additionally train the abuser behavior model.

Further, the feature data of the abusers transmitted to train the abuser behavior model may include feature data associated with activities before abuse among activities of the abusers. That is, the abuser behavior model may be trained to discern feature signs of abusers before abuse is consumed by other users of the service (e.g., received, viewed, downloaded, etc.). Thus, the asynchronous processor 314 may detect an abuser before the abuser performs a specific abusing behavior on the online service that is detectable by the other users of the online service.

As described above, to discern a feature sign before abuse in advance, the feature data may utilize features with respect to activities of abusers before abusing behaviors are detectable by the other users of the online service, other than features with respect to the abusing activities.

The following Table 1 shows examples of types of feature data according to at least one example embodiment, but the example embodiments are not limited thereto. In detail, the feature data of Table 1 are examples of types of feature data with respect to an SNS in which users may form, join and leave a community, upload content or comments in relation to the community, and chat with other users of the community. The types of feature data to be utilized may vary depending on a type of the service 311.

TABLE 1

| Order | Feature | Importance |
|---|---|---|
| 27 | Number of content uploads per minute | 0.153444 |
| 19 | Number of community closings | 0.077108 |
| 42 | Number of chatroom creations per day | 0.061853 |
| 10 | Number of account enrollments with same e- | 0.049075 |
| | mail address | |
| 28 | Number of comment uploads per minute | 0.048780 |
| 30 | Number of comment uploads per minute in | 0.042749 |
| | single community | |
| 39 | Whether community is available to public | 0.028192 |
| 38 | Whether content including rich snippet is | 0.023464 |
| | uploaded | |
| 6 | Whether phone number is verified | 0.021459 |
| 40 | Number of content uploads in single community | 0.020597 |
| 16 | Number of searches | 0.020208 |
| 24 | Number of community invitation refusals | 0.019468 |
| 18 | Number of sub-community deletions in single | 0.015125 |
| | community | |
| 37 | Number of content uploads including URL | 0.013255 |
| 3 | Whether email is verified | 0.011704 |
| 29 | Number of content uploads per minute in single | 0.010050 |
| | community | |
| 41 | Number of chatroom invitations per day | 0.007708 |
| 7 | Number of account enrollments with same | 0.006907 |
| | phone number | |
| 12 | Whether profile includes profile image | 0.006871 |
| 36 | Number of content uploads including function | 0.006499 |
| | available to member | |
| 17 | Number of sub-community joins in single | 0.005500 |
| | community | |
| 23 | Number of community invitations per 5 minutes | 0.005042 |
| 33 | Number of content reports | 0.004991 |
| 20 | Number of community creations | 0.004630 |
| 45 | Number of chat blockings | 0.003775 |
| 11 | Whether profile includes name | 0.003462 |
| 13 | Whether profile includes birthday | 0.002353 |
| 14 | Whether profile includes gender | 0.001986 |
| 44 | Number of chat limitations | 0.001805 |
| 31 | Number of content upload limitations | 0.001603 |
| 43 | Number of chat reports | 0.001599 |
| 34 | Number of comment reports | 0.001254 |
| 32 | Number of comment limitations | 0.001229 |
| 25 | Number of community invitation reports | 0.000953 |
| 21 | Number of attempts to create community with | 0.000523 |
| | banned word | |
| 22 | Number of attempts to describe community with | 0.000509 |
| | banned word | |
| 26 | Number of community invitation penalties | 0.000328 |
| 35 | Number of attempts to upload file including | 0.000128 |
| | banned word | |
| . . . | . . . | . . . |

Table 1 shows a portion of 45 types of feature data, however the example embodiments are not limited thereto. Here, Table 1 lists the types of features in order of importance. Such per-type importances (e.g., importance scores, importance multipliers, etc.) for the features may be calculated in a process of training the abuser behavior model through machine learning with respect to the feature data. It may be easily understood by a person skilled in the art that the types of the features and/or calculated importances utilized for the service 311 may vary depending on the type of the service 311. For example, in addition to the features described above, an operation pattern of a bot used by an abuser may also be utilized as a feature. For example, operations of uploading the same comment or similar comments at specified intervals, such as intervals of 5 seconds, etc., may be recognized as an operation pattern of a bot, and the operation pattern may be set as a feature. In this example, operations of the bot may be recognized as activities of a user, and thus feature data with respect to the operation pattern may be generated by associating and analyzing a plurality of consecutive activities.

Further, an abuser probability may be calculated through the abuser behavior model based on feature data with respect to all of the features of the types described above or may be calculated based on data with respect to features of a desired and/or preset number of types selected based on the importances. For example, in an example in which the desired and/or preset number is “10”, feature data with respect to features with top “10” importances in Table 1 may be transmitted as parameters, and the abuser behavior model may calculate and return an abuser probability through the received feature data with respect to the features with the top “10” importances as the parameters.

As described above, according to at least one example embodiment, an abuser may be detected before an abusing behavior occurs by determining whether a user is an abuser by assigning an abuser probability to the user for each activity of the user on the online service prior to the activity being permitted to be uploaded/posted/transmitted to the online service, rather than detecting an abuser based on the contents of the abuse after an abusing behavior occurs on the online service. In addition, by training an abuser behavior model to calculate an abuser probability to predict the behaviors of abusers before abuse based on feature data of the abusers before abuse, prediction of whether a user is an abuser may be predicted more accurately through signs associated with known abusers and/or known abuse events.

Meanwhile, a restriction on an abuser requested from the asynchronous processor 314 through the restriction API 319 may include an abuser-imperceptible restriction that is not perceptible by an abuser. For example, the abuser-imperceptible restriction may include a restriction on the abuser's ability to upload data associated with a new activity of the abuser to the service 311 and limit an exposure channel through which the uploaded data is exposed to other users through the service 311. In further detail, limiting the exposure channel may include at least one of limiting a transmission of a push notification with respect to the uploaded data (for example, limiting a transmission of a push notification to people of the same community (e.g., a forum, a chat group, a community website, a blog, a comments section for a webpage, etc.) that the abuser joins, etc.), limiting an exposure of the uploaded data through a region in which new data is exposed to the other users (for example, limiting an exposure of data uploaded by the abuser in a region in which data of a community to which a normal user B belongs is exposed (e.g., hiding the data uploaded by the abuser from the view of the normal user B, flagging the data uploaded by the abuser as being potential abuse/spam/etc.), etc.), and limiting an exposure of a notification to notify a presence of new data in relation to the uploaded data (for example, limiting an exposure of a notification to the user B to notify that new data is uploaded in relation to the community to which the normal user B belongs, etc.).

As described above, since the abuser may be unaware of the restriction imposed on the abuser, the abuser may not notice that he or she was detected as an abuser and the restriction was imposed on him or her and thus, may not make an effort to analyze or avoid abuser detection.

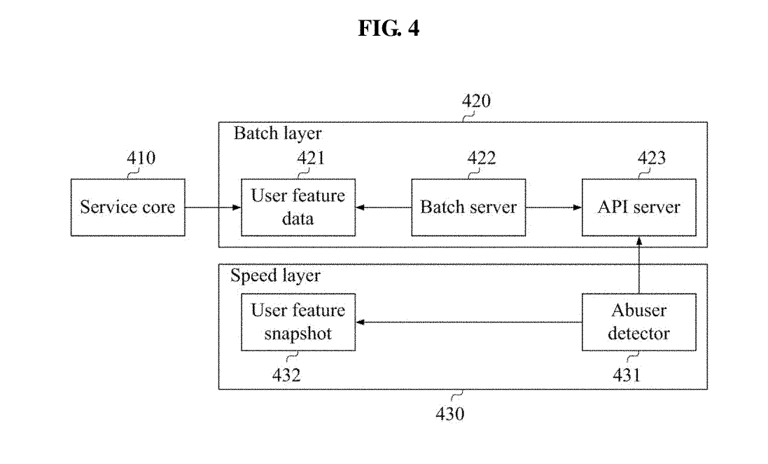

FIG. 4 is a diagram illustrating an example of a dataflow according to at least one example embodiment.

A service core 410 may refer to a module and/or a function to transmit an event occurring in response to an activity of a user, as in the service 311 of FIG. 3.

A batch layer 420 may be a layer to extract feature data 421 of a user through the received event and generate an abuser behavior model based on the feature data 421 of the user extracted from a batch server 422. The generated abuser behavior model may be called and used through an API server 423. The batch layer 420 may transmit and process data relatively slowly when compared to a speed layer 430. As described with reference to FIG. 3, events may be stored in the message queue 313 and asynchronously and sequentially processed. XXX

The speed layer 430 may transmit and process data quickly for each activity of users. Each time a user performs one activity, an abuser detector 431 may determine whether the user is an abuser quickly using a user feature snapshot 432 stored in the cache 316 of FIG. 3. The abuser detector 431 may correspond to the asynchronous processor 314 of FIG. 3. The abuser detector 431 may extract feature data quickly from events received in response to activities of the user, update the user feature snapshot 432, and call the abuser behavior model through the API server 423 using feature data of the updated user feature snapshot 432 as parameters. As already described above, the abuser behavior model may calculate and return an abuser probability based on the feature data of the updated user feature snapshot 432, and the abuser detector 431 may determine whether the corresponding user is an abuser based on the returned abuser probability.

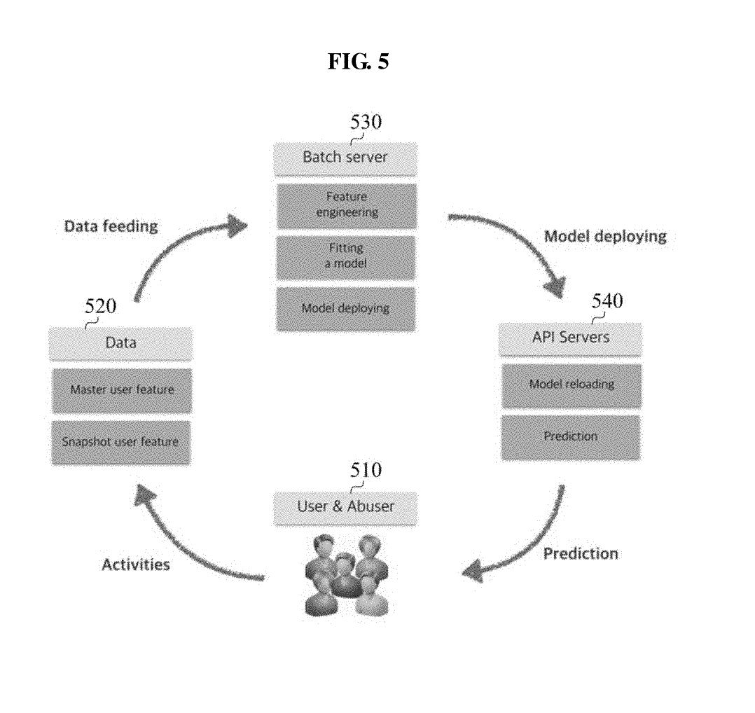

FIG. 5 is a diagram illustrating an example of a loop structure of abuser detection and training of an abuser behavior model according to at least one example embodiment.

FIG. 5 illustrates an example of generating data 520 in response to activities of users 510 including an abuser. In this example, a master user feature may refer to feature data stored in the DB 315 of FIG. 3, and a snapshot user feature may refer to a snapshot with respect to latest feature data of a user stored in the cache 316 of FIG. 3. The generated data may be fed to a batch server 530.

In this example, as shown in feature engineering, fitting a model, and model deploying of FIG. 5, the batch server 530 may extract, analyze, and process feature data of the user in the data 520, train an abuser behavior model using the feature data, and distribute the trained abuser behavior model in a form of a file to an API server 540.

As shown in model reloading and prediction of FIG. 5, the API server 540 may load the abuser behavior model distributed in the form of a file on a memory, and calculate and return an abuser probability through the abuser behavior model loaded to the memory in response to an API call of the model or function to determine whether the user is an abuser, for example, the asynchronous processor 314 or the abuser detector 431 described above. In this example, the API call may include feature data of the user for which an abuser probability is to be calculated, and the abuser behavior model may calculate the abuser probability using the feature data as parameters.

In response to the specific user being determined to be an abuser based on the calculated abuser probability, the process of training the abuser probability model and determining whether the user is an abuser based on the activities of the users 510 including the abuser may be performed repeatedly. As already described above, the process of training the abuser probability model may be included in the batch layer 420 of FIG. 4 and be asynchronously performed relatively slowly when compared to the process of determining whether the user is an abuser by the speed layer 430.

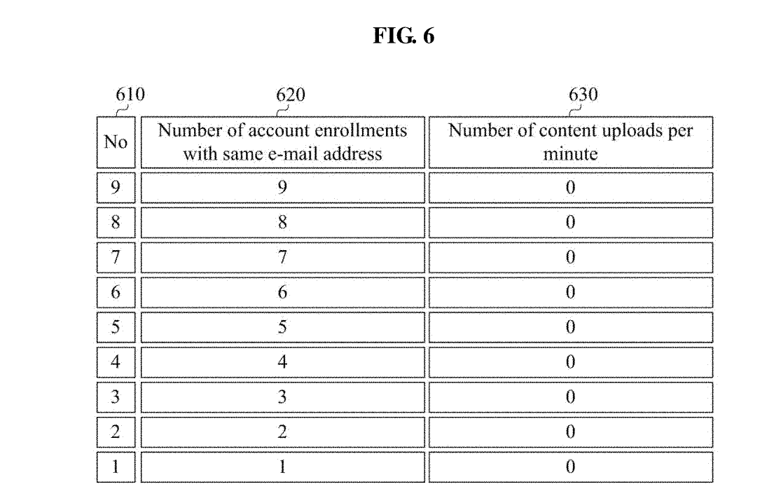

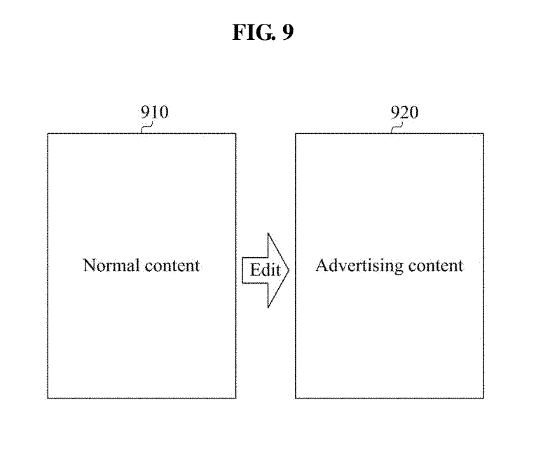

FIGS. 6 through 9 illustrate an abusing process and an example of determining a user to be an abuser and setting an abuser-imperceptible restriction in response to the abusing process.

FIG. 6 illustrates an example of generating feature data associated with activities of a specific user C. In FIG. 6, “No” 610 denotes an activity number of the user C, and “number of account enrollments with same e-mail address” 620 and “number of content uploads per minute” 630 are represented as two items of feature data associated with the activities. Referring to FIG. 6, the user C did not upload any content until a total of “9” account enrollments were made with the same e-mail address.

Such feature data may be transmitted to an abuser behavior model as parameters, and the abuser behavior model may return an abuser probability calculated using the parameters.

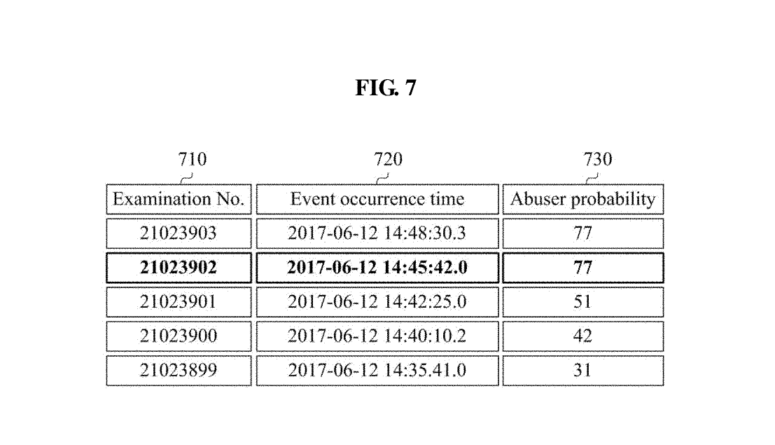

FIG. 7 illustrates an example in which an abuser probability is calculated for each activity of the user C and the abuser probability exceeds a desired and/or preset threshold 70% after a desired and/or predetermined activity. In this example, the user C may be determined to be an abuser, and an abuser-imperceptible restriction that is not perceptible by the user C may be set. For example, an exposure channel through which data such as content or comments uploaded by the user C is exposed to other users may be limited. For example, a transmission of a push notification with respect to the data uploaded by the user C may be limited.

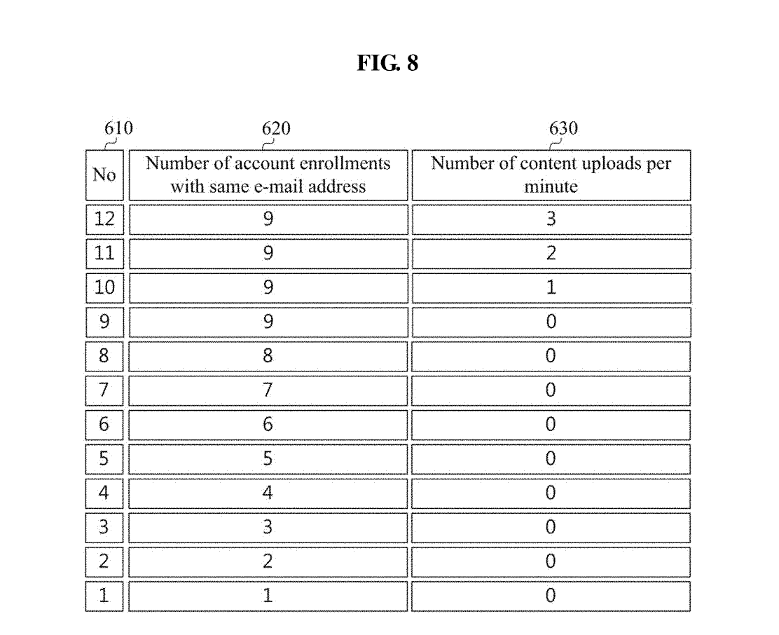

FIG. 8 illustrates an example in which the user C uploads normal content 910 and then edits the normal content 910 to advertising content 920 after a desired and/or preset time (for example, “3” minutes) to avoid being detected as abuse (for example, an upload of spam content) based on the contents of the content.

In the related art, it is very difficult, if not impossible, to block an upload of the normal content 910, and thus a push notification with respect to the normal content 910 may be transmitted to other users in response to the normal content 910 being uploaded. However, when the other users access the normal content 910 through the push notification, the advertising content 920 may be exposed to the other users since the normal content 910 was already edited to the advertising content 920.

However, according to at least one example embodiment, the user C may be already determined to be an abuser before uploading the normal content 910, and thus the advertising content 920 as well as the normal content 910 may not be exposed to the other users. As already described above, such a restriction may include limiting various exposure channels through which data uploaded by the user C is exposed to the other users, in addition to limiting the transmission of the push notification. Such restrictions may apply to all three content uploads of the user as in FIG. 8.

Such an abuser-imperceptible restriction may not allow an abuser to perceive that he or she was determined to be an abuser and to perceive the restriction imposed on data of his or hers, and thus the abuser may not feel a need of attempting to analyze or avoid abuser detection.

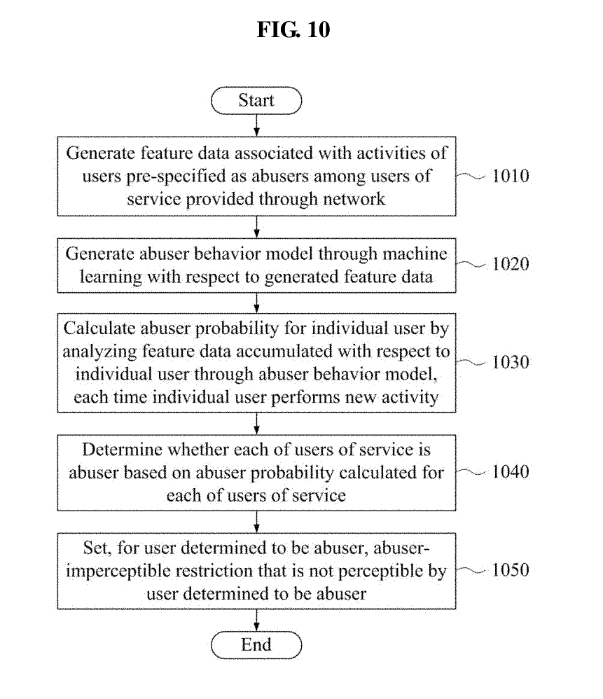

FIG. 10 is a flowchart illustrating an example of an abuser detection method according to at least one example embodiment. The abuser detection method may be performed by a computer apparatus, for example, the server 150 described above. In this example, the processor 222 of the server 150 may be configured to execute control instructions according to a code of at least one program or a code of an OS included in the memory 221. Here, the processor 222 may control the server 150 to perform operations 1010 through 1050 included in the abuser detection method of FIG. 10 based on the control instructions provided by codes stored in the server 150.

In operation 1010, the server 150 may generate feature data associated with activities of users pre-specified as abusers among users of a service provided through a network. For example, the server 150 may generate feature data associated with activities before abuse among the activities of the users pre-specified as abusers. Such feature data associated with activities before abuse may represent features with respect to signs before abuse of an abuser.

In operation 1020, the server 150 may generate an abuser behavior model through machine learning with respect to the generated feature data. For example, the server 150 may generate the abuser behavior model to predict behaviors of the abusers before abuse based on feature data of the abusers before abuse.

In operation 1030, the server 150 may calculate an abuser probability for an individual user by analyzing feature data accumulated with respect to the individual user through the abuser behavior model, each time the individual user performs a new activity. In this example, the feature data may include data relating to a plurality of features classified by a plurality of types. Examples of the plurality of features classified by the plurality of types were already described above through Table 1. The plurality of features may vary depending on a service being provided. For example, it was already described that an operation pattern of a bot used by an abuser may be utilized as the feature data, although not included in Table 1. Further, in operation 1020, the server 150 may also calculate per-type importances of the plurality of features through the machine learning. In this example, in operation 1030, the server 150 may calculate the abuser probability for the individual user based on data relating to features of a desired and/or preset number of types selected based on the per-type importances among the feature data accumulated with respect to the individual user, for all types of features.

In operation 1040, the server 150 may determine whether each of the users of the service is an abuser based on an abuser probability calculated for each of the users of the service. For example, the server 150 may determine a user having the calculated abuser probability exceeding a desired and/or preset threshold (for example, 70%) to be an abuser. In this example, the server 150 may arrange and provide information associated with users determined to be abusers in order of the calculated abuser probability closest to the desired and/or preset threshold, to examine the users determined to be abusers. This is because as the abuser probability is closer to the desired and/or preset threshold, a probability that the corresponding user is not an abuser may increase.

In operation 1050, the server 150 may set, for a user determined to be an abuser, an abuser-imperceptible restriction that is not perceptible by the user determined to be abuser. For example, the server 150 may allow an upload of data associated with a new activity of the user determined to be an abuser to the service and limit an exposure channel through which the uploaded data is exposed to other users through the service. For this, the server 150 may limit a transmission of a push notification with respect to the uploaded data, limit an exposure of the uploaded data through a region in which new data is exposed to the other users, and/or limit an exposure of a notification to notify a presence of new data in relation to the uploaded data.

As described above, according to one or more example embodiments, an occurrence of abuse may be decreased and/or prevented by detecting an abuser based on features of users of a service and imposing a restriction on the abuser before abuse occurs. Further, an abuser-imperceptible restriction that is not perceptible by detected abusers may be imposed on the detected abusers such that the detected abusers may not make an effort to analyze an abuser detection scheme or avoid abuser detection.

The systems and or apparatuses described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable storage mediums.

The methods according to the example embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially to store and perform program instructions, such as read-only memory (ROM, random access memory (RAM, flash memory, and the like. Examples of program instructions include both machine code, such as produced by a compiler, and files containing higher level code that may be executed by the computer using an interpreter. The described hardware devices may be to act as one or more software modules in order to perform the operations of the above-described embodiments, or vice versa.

The foregoing description has been provided for purposes of illustration and description. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An abuser detection method, comprising:
generating feature data associated with activities of users pre-specified as abusers among users of a service provided through a network;
generating an abuser behavior model through machine learning with respect to the generated feature data;
calculating an abuser probability for an individual user by analyzing feature data accumulated with respect to the individual user through the abuser behavior model, each time the individual user performs a new activity; and
determining whether each of the users of the service is an abuser based on an abuser probability calculated for each of the users of the service.

2. The abuser detection method of claim 1, wherein the generating of the feature data comprises generating feature data associated with activities before abuse among the activities of the users pre-specified as abusers, and
the generating of the abuser behavior model comprises generating the abuser behavior model to predict behaviors of the abusers before abuse based on feature data of the abusers before abuse.

3. The abuser detection method of claim 1, further comprising:
setting, for a user determined to be an abuser, an abuser-imperceptible restriction that is not perceptible by the user determine to be an abuser.

4. The abuser detection method of claim 3, wherein the setting comprises allowing an upload of data associated with a new activity of the user determined to be an abuser to the service and limiting an exposure channel through which the uploaded data is exposed to other users through the service.

5. The abuser detection method of claim 4, wherein the limiting comprises at least one of limiting a transmission of a push notification with respect to the uploaded data, limiting an exposure of the uploaded data through a region in which new data is exposed to the other users, and limiting an exposure of a notification to notify a presence of new data in relation to the uploaded data.

6. The abuser detection method of claim 1, wherein the feature data include data relating to a plurality of features classified by a plurality of types,
wherein the abuser detection method further comprises calculating per-type importances of the plurality of features through the machine learning,
wherein the calculating of the abuser probability comprises calculating the abuser probability for the individual user based on data relating to features of a desired number of types selected based on the per-type importances among the feature data accumulated with respect to the individual user.

7. The abuser detection method of claim 1, wherein the determining comprises determining a user having the calculated abuser probability exceeding a desired threshold to be an abuser.

8. The abuser detection method of claim 7, further comprising:
arranging and providing information associated with users determined to be abusers in order of the calculated abuser probability closest to the desired threshold, to examine the users determined to be abusers.

9. The abuser detection method of claim 1, wherein the feature data includes a number of content uploads per a desired first time, a number of community closings, a number of chatroom creations per a desired second time, a number of account enrollments with the same e-mail address, a number of comment uploads per a desired third time, a number of comment uploads per a fourth time in a single community, whether a community is available to the public, and whether content including a rich snippet is uploaded.

10. The abuser detection method of claim 1, wherein the feature data includes an operation pattern of a bot used by an abuser.

11. A non-transitory computer-readable recording medium storing instructions that, when executed by a processor, cause the processor to perform the abuser detection method of claim 1.

12. A computer apparatus, comprising:
at least one processor configured to execute computer-readable instructions,
wherein the at least one processor is configured to:
generate feature data associated with activities of users pre-specified as abusers among users of a service provided through a network,
generate an abuser behavior model through machine learning with respect to the generated feature data,
calculate an abuser probability for an individual user by analyzing feature data accumulated with respect to the individual user through the abuser behavior model, each time the individual user performs a new activity, and
determine whether each of the users of the service is an abuser based on an abuser probability calculated for each of the users of the service.

13. The computer apparatus of claim 12, wherein the at least one processor is configured to:
generate feature data associated with activities before abuse among the activities of the users pre-specified as abusers, and
generate the abuser behavior model to predict behaviors of the abusers before abuse based on feature data of the abusers before abuse.

14. The computer apparatus of claim 12, wherein the at least one processor is configured to set, for a user determined to be an abuser, an abuser-imperceptible restriction that is not perceptible by the user determined to be an abuser.

15. The computer apparatus of claim 14, wherein the at least one processor is configured to allow an upload of data associated with a new activity of the user determined to be an abuser to the service and limit an exposure channel through which the uploaded data is exposed to other users through the service.

16. The computer apparatus of claim 15, wherein the limiting comprises at least one of limiting a transmission of a push notification with respect to the uploaded data, limiting an exposure of the uploaded data through a region in which new data is exposed to the other users, and limiting an exposure of a notification to notify a presence of new data in relation to the uploaded data.

17. The computer apparatus of claim 12, wherein the feature data include data relating to a plurality of features classified by a plurality of types,
wherein the at least one processor is further configured to:
calculate per-type importances of the plurality of features through the machine learning, and
calculate the abuser probability for the individual user based on data relating to features of a preset number of types selected based on the per-type importances among the feature data accumulated with respect to the individual user.
